(19) United States
(12) Patent Application Publication
(10) Pub. No.: US 2024/0256829 A1
(43) Pub. Date: Aug. 1, 2024

(54) WIND POWER GENERATION QUANTILE PREDICTION METHOD BASED ON MACHINE MENTAL MODEL AND SELF-ATTENTION

(71) Applicant: University of Science and Technology Beijing, Beijing (CN)

(72) Inventors: Tianyu HU, Beijing (CN); Huimin MA, Beijing (CN); Xiao ZHANG, Beijing (CN); Hao LIU, Beijing (CN); Kangsheng WANG, Beijing (CN)

(73) Assignee: University of Science and Technology Beijing, Beijing (CN)

(21) Appl. No.: 18/243,107

(22) Filed: Sep. 7, 2023

(30) Foreign Application Priority Data
Jan. 6, 2023 (CN) 202310014898.7

(51) Int. Cl. G06N 3/042; G06N 3/084

(52) U.S. Cl. CPC G06N 3/042; G06N 3/084

(57) ABSTRACT

A wind power generation quantile prediction method based on machine mental model and self-attention includes: using human cognitive decision-making mechanism for reference to construct the machine mental model as the basic framework of WQPMMSA, and then the seasonal power generation rules and intraday power generation trend are encoded into WQPMMSA as the input information of the prediction method, using the self-attention layer to replace the recurrent neural network in the original machine mental model, and establishing the statistical relationship between the seasonal power generation rules and the intraday power generation trend effectively, reducing the long-range forgetting of the original machine mental model-convert the continuous rank probability score in the integral form into a summation form, and using it as a loss function to train WQPMMSA, so that WQPMMSA approaches the optimal quantile prediction result with the highest efficiency. Therefore, accurate quantile prediction of wind power generation is realized.

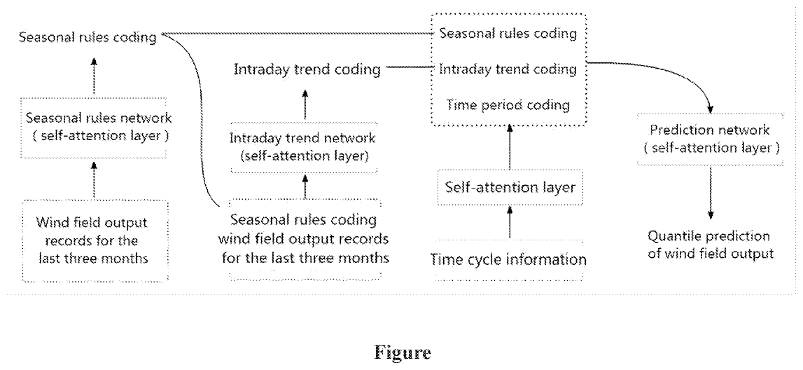

### CROSS REFERENCE TO THE RELATED APPLICATIONS

This application is based upon and claims priority to Chinese Patent Application No. 202310014898.7, filed on Jan. 6, 2023, the entire contents of which are incorporated herein by reference.

### TECHNICAL FIELD

The invention relates to a wind power generation prediction technology, in particular to a wind power generation quantile prediction method based on machine mental model and self-attention.

### BACKGROUND

Increasing the proportion of renewable energy such as wind power and photovoltaic in primary energy is an effective measure in line with the major strategic needs of China. In 2021, the proportion of wind power and photovoltaic power generation in the world's total power generation exceeded 1/10 for the first time, reaching 10.3%. Due to the high uncertainty of wind power output, its large-scale grid connection poses a great challenge to the safe operation of the power system. Accurate wind power prediction is one of the most effective methods to deal with uncertainty, which can provide sufficient safety margin for advanced scheduling, and then help to improve wind power consumption capacity.

Wind power prediction effectively reduces the uncertainty of the power generation side caused by the large-scale application of wind power. The existing prediction methods mainly focus on the deterministic (point) prediction of wind power output, and pay less attention to the probabilistic prediction method for wind power generation. The output of the deterministic prediction model is a conditional expectation (or mean). The output of the probabilistic prediction model is the distribution interval or quantile of the predicted target. Compared with the deterministic prediction model, the probabilistic prediction model is more able to capture the uncertainty of the prediction target, which brings higher flexibility to the optimal operation of the energy system, such as robust scheduling, stochastic programming, etc. Therefore, the probability prediction of wind power generation has great application potential and value in the actual operation of the power system, but it is currently facing the following challenges:

Question 1: Information balance between seasonal power generation rules (long-term) and intraday power generation trend (short-term)

The fluctuation of wind power generation is generally affected by two factors: (1) Long-term and seasonal airflow variation. For example, there are similar statistical laws of wind power output in the same wind site in summer. This factor can be obtained by statistical induction of long-term historical power generation curves, and it is stable to a certain extent. (2) The short-term intraday fluctuation of wind power output represents the short-term trend of the current airflow. In the wind power prediction model or method, how to organically combine long-term laws and short-term trends, and how to grasp the information balance of the above two points is one of the bottlenecks for accurate wind power prediction.

Question 2: Forgetting long-term information

The existing time series prediction methods are difficult to solve the problem of long-term forgetting, that is, the historical data far away will be forgotten or ignored. In the wind power prediction scenario, long-term historical information such as seasonal factors will still play an important guiding role in future wind power output prediction. Therefore, overcoming the long-term forgetting problem of existing prediction methods is also a challenge for current wind power prediction.

Problem 3: The evaluation index Continuous Ranked Probability Score (CRPS) is not derivable, so it cannot be used as the loss function of model training.

The evaluation index of quantile prediction (such as CRPS) is directly used as the loss function of model training, which can make the model aim at the highest quality quantile prediction result as soon as possible. However, the integral form of the existing CRPS is difficult to directly derive, so it cannot be directly used as a loss function for model training.

### SUMMARY

Aiming at problem 1, the invention considers the long-term seasonal rules and short-term intraday trend of wind power, the machine mental model is used to combine the seasonal rules and the intraday trend by referring to the human cognitive mechanism, that is, a wind power generation quantile prediction method based on machine mental model and self-attention (WQPMMSA). Two feature codes are constructed in WQPMMSA: seasonal rule code and intraday trend code; seasonal rule coding aims to summarize the statistical law of wind field output with seasonal variation from the daily power generation curve of the past three months, the intraday trend coding aims to capture the current trend of wind power output from recent power generation.

Aiming at problem 2, the invention discloses a wind power data coding method based on a self-attention mechanism, which imitates the cognitive process of human beings selectively focusing on one or several things and ignoring other things. In WQPMMSA, self-attention is used to replace the recurrent neural network in the original machine mental model, so as to establish a statistical relationship between seasonal power generation rules and intraday power generation trends effectively.

Aiming at question 3, the invention transforms the CRPS from the integral form to the summation form, the CRPS in the summation form is derivable, so it can be directly used as the loss function of the prediction model. In this invention, CRPS in the transformed summation form is directly used as the loss function of WQPMMSA.

The purpose of the invention is to provide a wind power generation quantile prediction method based on machine mental model and self-attention (WQPMMSA), WQPMMSA uses machine mental model as the framework to learn from human cognitive decision-making mechanism to achieve a reasonable balance between seasonal power generation rules and intraday power generation trends, at the same time, the purpose of alleviating long-term forgetting is achieved by establishing self-attention, and the sum CRPS is directly used as the loss function for training WQPMMSA, the above three points make WQPMMSA have excellent prediction ability and great application potential.

In order to achieve the above purpose, the invention provides a wind power generation quantile prediction method based on machine mental model and self-attention, including the following steps:
S1, constructing a basic architecture of WQPMMSA;
S11, quantile prediction problem description, and mathematical expression;
S12, constructing a machine mental model as the basic architecture of WQPMMSA, and then encoding seasonal power generation rules and short-term intraday power generation trend into WQPMMSA as input information of this prediction method, and integrating a self-attention mechanism into WQPMMSA as a link to connect each code and vector;
S2, training and prediction of WQPMMSA;
S21, using Continuous Ranked Probability Score (CRPS) as an evaluation index of WQPMMSA prediction results, and is transformed into a derivable form by derivation.
S22, using the transformed derivable CRPS as a loss function to train WQPMMSA;
S23, simulating the human psychological decision-making mechanism to predict the quantile of wind power generation by WQPMMSA using the machine mental model.

Preferably, Step S11 includes the following steps specifically:
S11, quantile prediction problem description, and mathematical expression
the given training data is {(xₜ,yₜ)}ₜ₌₁^{T}, where t is a timestamp, T is a coverage period, xₜ is an explanatory variable of the quantile prediction of wind power generation (such as the statistics of the seasonal power generation rules, the current wind field output trend, the weather prediction information, etc.), yₜ is a target variable, such as the power generation of a wind farm at time t; the goal of quantile prediction is to estimate the quantile of the probability distribution of yₜ₊ₕ:

$${x}_{t - D + 1} , {x}_{t - D + 2} , … , {x}_{t} \to [ {q}_{t + h}^{{α}_{1}} , {q}_{t + h}^{{α}_{2}} , … , {q}_{t + h}^{{α}_{r}} ] \qquad ( 1 )$$

among them, qₜ₊ₕ^{α} is a quantile when the cumulative probability of the probability distribution corresponding to yₜ₊ₕ is α, r is a number of sampled α, and D is a lag interval of the prediction task; if \hat{q}ₜ₊ₕ^{α} is used to represent the prediction or estimation of qₜ₊ₕ^{α}, then all the quantiles of prediction at time t can be written as \hat{q}ₜ₊ₕ=[\hat{q}ₜ₊ₕ^{α}^{₁}, \hat{q}ₜ₊ₕ^{α}^{₂}, . . . , \hat{q}ₜ₊ₕ^{α}^{ᵣ}]; then, the predicted quantiles at all times can be combined to represented as \hat{Q}=\hat{q}₁, \hat{q}₂ . . . , \hat{q}_{T}], \hat{Q}ϵR^{(T×r)}, or all observations of the predicted target variable yₜ can be combined as Y=[y₁, y₂, . . . , y_{T}].

Preferably, Step S12 includes the following steps specifically:
S121, establishing three networks of seasonal rules network, intraday trend network, and prediction network in WQPMMSA; the seasonal rules network aims to obtain the seasonal rules characteristics of wind farm output, the intraday trend network aims to estimate the intraday trend of wind power in recent hours; the prediction network is used to predict the quantile of wind power distribution after 1 hour;
the three parts of WQPMMSA, namely the seasonal rules network, the intraday trend network, and the prediction network, are all composed of a self-attention layer. Self-attention is an effective method to alleviate the long-term forgetting of neural networks, and its high parallelism brings high time efficiency, the core idea of self-attention is to use the mutual attention of input samples to re-express all input samples, assuming that the input sample matrix is X=[x₁, x₂, . . . , x_{N}]^{T}, where N is the total number of samples, the self-attention is calculated as follows:

$$Z = softmax ( \frac{Q \cdot {K}^{T}}{\sqrt{{d}_{k}}} ) \cdot V \qquad ( 2 )$$

among them:

$$Q = X \cdot {W}^{Q} , K = X \cdot {W}^{K} , V = X \cdot {W}^{V}$$

W^{Q}, W^{K}, W^{V} in the above formula are trainable weight matrices; Q, K, and V are query matrix, key matrix, and value matrix respectively, dₖ is a dimension of each row in Q; Z is an output of the self-attention layer, that is, the re-expression of each sample;
S122, constructing two feature codes in WQPMMSA: seasonal rules coding and intraday trend coding; the seasonal rules coding aims to summarize the statistical law of wind field output with seasonal variations from daily power generation curves in the past three months, the intraday trend coding aims to capture the current trend of wind power output from the recent power generation;
S123, combining seasonal rules coding, intraday trend coding, and time periodic information by WQPMMSA, and then outputting the quantile prediction value of wind power generation by predicting the network.

Preferably, Step S21 includes the following steps specifically:
S21, adopting Continuous Ranked Probability Score(CRPS) as an evaluation index of WQPMMSA prediction results, and transforming it into a derivable form by derivation;
CRPS is a comprehensive quantile evaluation index, which takes into account the reliability and sharpness of the predicted quantile, it is defined as follows:

$${𝒮}_{CRPS} ( \hat{Q} , Y ) = \frac{1}{T} {\sum }_{t = 1}^{T} {\int }_{- ∞}^{+ ∞} {[ {\hat{F}}_{t} ( p ) - ε ( p - {y}_{t} ) ]}^{2} dp \qquad ( 3 )$$

among them, \hat{F}ₜ(⋅) is obtained by linear interpolation of {(\hat{q}ₜ^{α}^{ᵢ}, αᵢ)}ᵢ₌₀^{r+1} (where \hat{q}ₜ^{α}^{ᵣ₊₁} and \hat{q}ₜ^{α}^{₀} represent the upper and lower bounds of yₜ, respectively, and a₀=0, aᵣ₊₁=1), ε(⋅) is a step function defined as follows:

$$ε ( x ) = \{ \begin{matrix}1 , & if x \geq 0 \\ 0 , & if x < 0\end{matrix} \qquad ( 4 )$$

after regularizing yₜ to [0, 1], formula (3) is simplified as follows:

$${𝒮}_{CRPS} ( \hat{Q} , Y ) = \frac{1}{T} {\sum }_{t = 1}^{T} {\int }_{0}^{1} {[ {\hat{F}}_{t} ( p ) - ε ( p - {y}_{t} ) ]}^{2} dp \qquad ( 5 )$$

proving that the CRPS integral in formula (5) is equivalently rewritten as the following derivable form:

$${𝒮}_{CRPS} ( \hat{Q} , Y ) = \frac{1}{T} {\sum }_{t = 1}^{T} ( {C}_{t} + 1 - {y}_{t} ) ) \qquad ( 6 )$$

among them:

$${C}_{t} = {\sum }_{i = 0}^{r} \{ \begin{matrix}\frac{{( {A}_{t}^{i} \cdot {\hat{q}}_{t}^{{α}_{i + 1}} + {B}_{t}^{i} )}^{3}}{3 {A}_{t}^{i}} - \frac{{( {A}_{t}^{i} \cdot {\hat{q}}_{t}^{{α}_{i}} + {B}_{t}^{i} )}^{3}}{3 {A}_{t}^{i}} \\ \{ {A}_{t}^{i} [ {( {\hat{q}}_{t}^{{α}_{i + 1}} )}^{2} - {{y}_{t}}^{2} ] + 2 {B}_{t}^{i} ( {\hat{q}}_{t}^{{α}_{i + 1}} - {y}_{t} ) \} \cdot {I}_{( {\hat{q}}_{t}^{{α}_{i}} , {\hat{q}}_{t}^{{α}_{i + 1}} )} ( {y}_{t} ) - \\ \{ {A}_{t}^{i} [ {( {\hat{q}}_{t}^{{α}_{i + 1}} )}^{2} - {( {\hat{q}}_{t}^{{α}_{i}} )}^{2} ] + 2 {B}_{t}^{i} ( {\hat{q}}_{t}^{{α}_{i + 1}} - {\hat{q}}_{t}^{{α}_{i}} ) \} \cdot [ 1 - ε ( {y}_{t} - {\hat{q}}_{t}^{{α}_{i}} ) ]\end{matrix} \} \qquad ( 7 )$$

$${A}_{t}^{i} = \frac{{α}_{i + 1} - {α}_{i}}{{\hat{q}}_{t}^{{α}_{i + 1}} - {\hat{q}}_{t}^{{α}_{i}}} , {B}_{t}^{i} = \frac{{α}_{i} \cdot {\hat{q}}_{t}^{{α}_{i + 1}} - {α}_{i + 1} \cdot {\hat{q}}_{t}^{{α}_{i}}}{{\hat{q}}_{t}^{{α}_{i + 1}} - {\hat{q}}_{t}^{{α}_{i}}} \qquad ( 8 )$$

$${I}_{( {\hat{q}}_{t}^{{α}_{i}} , {\hat{q}}_{t}^{{α}_{i + 1}} )} ( {y}_{t} ) = ε ( {y}_{t} - {\hat{q}}_{t}^{{α}_{i}} ) \cdot [ 1 - ε ( {y}_{t} - {\hat{q}}_{t}^{{α}_{i + 1}} ) ] \qquad ( 9 )$$

the proof of the above conclusion is as follows:
if the given prediction quantile is:

$$( {\hat{q}}_{t}^{{α}_{i}} , {α}_{i} ) , i = 0 , 1 , ... , r + 1 \qquad ( 10 )$$

$$among them , {α}_{0} = {\hat{q}}_{t}^{{α}_{0}} = 0 , {α}_{r + 1} = {\hat{q}}_{t}^{{α}_{r + 1}} = 1.$$

$$then :$$

$${𝒮}_{CRPS} ( \hat{Q} , Y ) = \frac{1}{T} {\sum }_{t = 1}^{T} {\int }_{0}^{1} {[ {F}_{t} ( p ) - ε ( p - {y}_{t} ) ]}^{2} dp \qquad ( 11 )$$

where Fₜ(p) is obtained by linear interpolation on (\hat{q}ₜ^{α}^{ᵢ}, αᵢ)ᵢ₌₀^{r+1};
the line segments determined by (\hat{q}ₜ^{α}^{ᵢ}, αᵢ) and (\hat{q}ₜ^{α}^{ᵢ₊₁}, αᵢ₊₁) can be expressed by the following formula:

$$z = {A}_{t}^{i} \cdot p + {B}_{t}^{i} \qquad ( 12 )$$

$${A}_{t}^{i} = \frac{{α}_{i + 1} - {α}_{i}}{{\hat{q}}_{t}^{{α}_{i + 1}} - {\hat{q}}_{t}^{{α}_{i}}} , {B}_{t}^{i} = \frac{{α}_{i} \cdot {\hat{q}}_{t}^{{α}_{i + 1}} - {α}_{i + 1} \cdot {\hat{q}}_{t}^{{α}_{i}}}{{\hat{q}}_{t}^{{α}_{i + 1}} - {\hat{q}}_{t}^{{α}_{i}}} \qquad ( 13 )$$

since Fₜ(p) is piecewise, its feasible region can be divided into the following mutually exclusive parts:

$$[ 0 , 1 ] ⇔ [ {\hat{q}}_{t}^{{α}_{0}} , {\hat{q}}_{t}^{{α}_{1}} ) ⋃ … ⋃ [ {\hat{q}}_{t}^{{α}_{i}} , {\hat{q}}_{t}^{{α}_{i + 1}} ) ⋃ … [ {\hat{q}}_{t}^{{α}_{r}} , {\hat{q}}_{t}^{{α}_{r + 1}} ) ⋃ {\hat{q}}_{t}^{{α}_{r + 1}} \qquad ( 14 )$$

Fₜ(p) is continuously derivable in each segment except the last isolated point \hat{q}ₜ^{a}^{ᵣ₊₁}; an indicator function corresponding to the probability interval [\hat{q}ₜ^{a}^{ᵢ}, \hat{q}ₜ^{a}^{ᵢ₊₁}) can be transformed into:

$$p ∈ [ {\hat{q}}_{t}^{{α}_{i}} , {\hat{q}}_{t}^{{α}_{i + 1}} ) ⇒ p ∈ [ {\hat{q}}_{t}^{{α}_{i}} , + ∞ ) ⋂ ( - ∞ , {\hat{q}}_{t}^{{α}_{i + 1}} ) ⇒ ε ( p - {\hat{q}}_{t}^{{α}_{i}} ) = 1 and 1 - ε ( p - {\hat{q}}_{t}^{{α}_{i + 1}} ) = 1 ⇔ ε ( p - {\hat{q}}_{t}^{{α}_{i}} ) \cdot [ 1 - ε ( p - {\hat{q}}_{t}^{{α}_{i + 1}} ) ] = 1 \qquad ( 15 )$$

the indicator function corresponding to the last boundary point \hat{q}ₜ^{a}^{ᵣ₊₁} can be transformed into:

$$p = {\hat{q}}_{t}^{{α}_{r + 1}} ⇒ p ∈ [ {\hat{q}}_{t}^{{α}_{r + 1}} , {\hat{q}}_{t}^{{α}_{r + 1}} ] ⇒ p ∈ [ {\hat{q}}_{t}^{{α}_{r + 1}} , + ∞ ) ⋂ ( - ∞ , {\hat{q}}_{t}^{{α}_{r + 1}} ] ⇒ ε ( p - {\hat{q}}_{t}^{{α}_{r + 1}} ) = 1 and ε ( {\hat{q}}_{t}^{{α}_{r + 1}} - p ) = 1 ⇔ ε ( p - {\hat{q}}_{t}^{{α}_{r + 1}} ) \cdot ε ( {\hat{q}}_{t}^{{α}_{r + 1}} - p ) = 1 ⇔ ε ( p - 1 ) \cdot ε ( 1 - p ) = 1 \qquad ( 16 )$$

accordingly, Fₜ(p) can be re-expressed as:

$${F}_{t} ( p ) = {\sum }_{i = 0}^{r} \{ ε ( p - {\hat{q}}_{t}^{{α}_{i}} ) \cdot [ 1 - ε ( p - {\hat{q}}_{t}^{{α}_{i + 1}} ) ] \cdot ( {A}_{t}^{i} \cdot p + {B}_{t}^{i} ) \} + ε ( p - 1 ) \cdot ε ( 1 - p ) \qquad ( 17 )$$

combining formula (11) and formula (17) to obtain formula (18):

$${\int }_{0}^{1} {[ {F}_{t} ( p ) - ε ( p - {y}_{t} ) ]}^{2} dp = {\int }_{0}^{1} {\{ {\sum }_{i = 0}^{r} \{ ε ( p - {\hat{q}}_{t}^{{α}_{i}} ) \cdot [ 1 - ε ( p - {\hat{q}}_{t}^{{α}_{i + 1}} ) ] \cdot ( {A}_{t}^{i} \cdot p + {B}_{t}^{i} ) \} + ε ( p - 1 ) \cdot ε ( 1 - p ) - ε ( p - {y}_{t} ) \}}^{2} dp = {\sum }_{i = 0}^{r} {\int }_{0}^{1} \{ {{ε}^{2} ( p - {\hat{q}}_{t}^{{α}_{i}} ) [ 1 - ε ( p - {\hat{q}}_{t}^{{α}_{i}} ) ]}^{2} {( {A}_{t}^{i} p + {B}_{t}^{i} )}^{2} \} dp + {\int }_{0}^{1} {ε}^{2} ( p - 1 ) {ε}^{2} ( 1 - p ) dp + {\int }_{0}^{1} {ε}^{2} ( p - {y}_{t} ) dp + 2 {\sum }_{i = 0}^{r} {\sum }_{j = 0 , j \neq i}^{r} {\int }_{0}^{1} \{ ε ( p - {\hat{q}}_{t}^{{α}_{i}} ) [ 1 - ε ( p - {\hat{q}}_{t}^{{α}_{i}} ) ] ( {A}_{t}^{i} \cdot p + {B}_{t}^{i} ) ε ( p - {\hat{q}}_{t}^{{α}_{j}} ) [ 1 - ε ( p - {\hat{q}}_{t}^{{α}_{j + 1}} ) ] ( {A}_{i}^{j} \cdot p + {B}_{t}^{j} ) \} dp + 2 {\sum }_{i = 0}^{r} {\int }_{0}^{1} \{ ε ( p - {\hat{q}}_{t}^{{α}_{i}} ) \cdot [ 1 - ε ( p - {\hat{q}}_{t}^{{α}_{i + 1}} ) ] \cdot ( {A}_{t}^{i} \cdot p + {B}_{t}^{i} ) \cdot ε ( p - 1 ) \cdot ε ( 1 - p ) \} dp - 2 {\sum }_{i = 0}^{r} {\int }_{0}^{1} \{ ε ( p - {\hat{q}}_{t}^{{α}_{i}} ) \cdot [ 1 - ε ( p - {\hat{q}}_{t}^{{α}_{i + 1}} ) ] \cdot ( {A}_{t}^{i} \cdot p + {B}_{t}^{i} ) \cdot ε ( p - {y}_{t} ) \} dp - 2 {\int }_{0}^{1} ε ( p - 1 ) \cdot ε ( 1 - p ) ε ( p - {y}_{t} ) dp \qquad ( 18 )$$

then determining the following lemmas as the basis for further derivation:

$$Lemma 1 : for any x ∈ R \qquad ( 19 )$$

$${ε}^{2} ( x ) = ε ( x ) {and [ 1 - ε ( x ) ]}^{2} = 1 - ε ( x )$$

$$Lemma 2 : for any x ∈ R , and i \neq j \qquad ( 20 )$$

$$ε ( p - {q}_{t}^{⋀ α i} ) \cdot [ 1 - ε ( p - {q}_{t}^{⋀ α i + 1} ) ] \cdot ε ( p - {q}_{t}^{⋀ α j} ) \cdot [ 1 - ε ( p - {q}_{t}^{⋀ α j + 1} ) ] = 0$$

Lemma 3: for any finite function f(x) on R, it has the following result:

$${\int }_{0}^{1} ε ( p - 1 ) \cdot [ 1 - ε ( p - 1 ) ] \cdot f ( p ) dp = 0 \qquad ( 21 )$$

it is proved in the following:

$${\int }_{0}^{1} ε ( p - 1 ) \cdot ε ( 1 - p ) \cdot f ( p ) dp = {lim}_{u \to {1}^{-}} {\int }_{0}^{u} ε ( p - 1 ) \cdot ε ( 1 - p ) \cdot f ( p ) dp + {lim}_{u \to {1}^{-}} {\int }_{u}^{1} ε ( p - 1 ) \cdot ε ( 1 - p ) \cdot f ( p ) dp = 0 + {lim}_{u \to {1}^{-}} f ( u ) \cdot ( 1 - u ) = f ( 1 ) \cdot 0 = 0 \qquad ( 22 )$$

combining with formula (19), formula(20), and formula (21), formula (18) is simplified as follows:

$${\int }_{0}^{1} {\{ \begin{matrix}{\sum }_{i = 0}^{r} \{ ε ( p - {\hat{q}}_{t}^{{α}_{i}} ) \cdot [ 1 - ε ( p - {\hat{q}}_{t}^{{α}_{i + 1}} ) ] \cdot ( {A}_{t}^{i} \cdot p + {B}_{t}^{i} ) \} + \\ ε ( p - 1 ) \cdot ε ( 1 - p ) - ε ( p - {y}_{t} )\end{matrix} \}}^{2} dp = {\sum }_{i ==}^{r} \{ \begin{matrix}{\int }_{0}^{1} \{ ε ( p - {\hat{q}}_{t}^{{α}_{i}} ) \cdot [ 1 - ε ( p - {\hat{q}}_{t}^{{α}_{i + 1}} ) ] \cdot {( {A}_{t}^{i} \cdot p + {B}_{t}^{i} )}^{2} \} dp - \\ 2 {\int }_{0}^{1} \{ ε ( p - {\hat{q}}_{t}^{{α}_{i}} ) \cdot [ 1 - ε ( p - {\hat{q}}_{t}^{{α}_{i + 1}} ) ] \cdot ( {A}_{t}^{i} \cdot p + {B}_{t}^{i} ) \cdot ε ( p - {y}_{t} ) \} dp\end{matrix} \} + 1 - {y}_{t} \qquad ( 23 )$$

Because ∫₀¹{ε(p−\hat{q}ₜ^{α}^{ᵢ})·[1−ε(p−\hat{q}ₜ^{α}^{ᵢ₊₁}]·(Aₜⁱ·p+Bₜⁱ)²}dp is equal to the area of curve zᵢ=(Aₜⁱ·p+Bₜⁱ)² between p=\hat{q}ₜ^{α}^{ᵢ} and p=\hat{q}ₜ^{α}^{ᵢ₊₁}, therefore:

$${\int }_{0}^{1} \{ ε ( p - {\hat{q}}_{t}^{{α}_{i}} ) \cdot [ 1 - ε ( p - {\hat{q}}_{t}^{{α}_{i + 1}} ) ] \cdot {( {A}_{t}^{i} \cdot p + {B}_{t}^{i} )}^{2} \} {d}_{P} = \frac{{( {A}_{t}^{i} \cdot {\hat{q}}_{t}^{{α}_{i + 1}} + {B}_{t}^{i} )}^{3}}{3 {A}_{t}^{i}} - \frac{{( {A}_{t}^{i} \cdot {\hat{q}}_{t}^{{α}_{i}} + {B}_{t}^{i} )}^{3}}{3 {A}_{t}^{i}}$$

$$however , {\int }_{0}^{1} \{ ε ( p - {\hat{q}}_{t}^{{α}_{i + 1}} ) \cdot [ 1 - ε ( p - {\hat{q}}_{t}^{{α}_{i + 1}} ) ] \cdot ( {A}_{t}^{i} \cdot p + {B}_{t}^{i} ) \cdot ε ( p - {y}_{t} ) \} dp$$

can be equivalently converted into the following three cases:

$$\begin{matrix}( A ) & \\ when {\hat{q}}_{t}^{{α}_{i}} < {y}_{t} , {\hat{q}}_{t}^{{α}_{i + 1}} \leq {y}_{t} , namely ε ( {y}_{t} - {\hat{q}}_{t}^{{α}_{i + 1}} ) = 1 , & ( 25 )\end{matrix}$$

$${\int }_{0}^{1} \{ ε ( p - {\hat{q}}_{t}^{{α}_{i}} ) \cdot [ 1 - ε ( p - {\hat{q}}_{t}^{{α}_{i + 1}} ) ] \cdot ( {A}_{t}^{i} \cdot p + {B}_{t}^{i} ) \cdot ε ( p - {y}_{t} ) \} dp = 0$$

$$\begin{matrix}( B ) & \\ when {\hat{q}}_{t}^{{α}_{i}} \leq {y}_{t} < {\hat{q}}_{t}^{{α}_{i + 1}} , namely ε ( {y}_{t} - {\hat{q}}_{t}^{{α}_{i}} ) \cdot [ 1 - ε ( {y}_{t} - {\hat{q}}_{t}^{{α}_{i + 1}} ) ] = 1 & ( 26 )\end{matrix}$$

$${\int }_{0}^{1} \{ ε ( p - {\hat{q}}_{t}^{{α}_{i}} ) \cdot [ 1 - ε ( p - {\hat{q}}_{t}^{{α}_{i + 1}} ) ] \cdot ( {A}_{t}^{i} \cdot p + {B}_{t}^{i} ) \cdot ε ( p - {y}_{t} ) \} dp = \frac{1}{2} {A}_{t}^{i} [ {( {\hat{q}}_{t}^{{α}_{i + 1}} )}^{2} - {y}_{t}^{2} ] + {B}_{t}^{i} ( {\hat{q}}_{t}^{{α}_{i + 1}} - {y}_{t} )$$

$$\begin{matrix}( C ) & \\ when {y}_{t} < {\hat{q}}_{t}^{{α}_{i}} , namely [ 1 - ε ( {y}_{t} - {\hat{q}}_{t}^{{α}_{i}} ) ] = 1 & ( 27 )\end{matrix}$$

$${\int }_{0}^{1} \{ ε ( p - {\hat{q}}_{t}^{{α}_{i}} ) \cdot [ 1 - ε ( p - {\hat{q}}_{t}^{{α}_{i + 1}} ) ] \cdot ( {A}_{t}^{i} \cdot p + {B}_{t}^{i} ) \cdot ε ( p - {y}_{t} ) \} dp = \frac{1}{2} {A}_{t}^{i} [ {( {\hat{q}}_{t}^{{α}_{i + 1}} )}^{2} - {( {\hat{q}}_{t}^{{α}_{i}} )}^{2} ] + {B}_{t}^{i} ( {\hat{q}}_{t}^{{α}_{i + 1}} - {\hat{q}}_{t}^{{α}_{i}} )$$

Combining formula (23), formula (24), formula (25), formula (26), and formula (27) to obtain formula (28):

$${\int }_{0}^{1} {\{ \begin{matrix}{\sum }_{i = 0}^{r} \{ ε ( p - {\hat{q}}_{t}^{{α}_{i}} ) \cdot [ 1 - ε ( p - {\hat{q}}_{t}^{{α}_{i + 1}} ) ] ( {A}_{t}^{i} p + {B}_{t}^{i} ) \} + \\ ε ( p - 1 ) ε ( 1 - p ) - ε ( p - {y}_{t} )\end{matrix} \}}^{2} dp = 1 - {y}_{t} + {\sum }_{i = 0}^{r} \{ \begin{matrix}\begin{matrix}\begin{matrix}\frac{{( {A}_{t}^{i} {\hat{q}}_{t}^{{α}_{i + 1}} + {B}_{t}^{i} )}^{3}}{3 {A}_{t}^{i}} - \frac{{( {A}_{t}^{i} {\hat{q}}_{t}^{{α}_{i}} + {B}_{t}^{i} )}^{3}}{3 {A}_{t}^{i}} - \\ \{ {A}_{t}^{i} [ {( {\hat{q}}_{t}^{{α}_{i + 1}} )}^{2} - {y}_{t}^{2} ] + 2 {B}_{t}^{i} ( {\hat{q}}_{t}^{{α}_{i + 1}} - {y}_{t} ) \}\end{matrix} \\ ε ( {y}_{t} - {\hat{q}}_{t}^{{α}_{i}} ) [ 1 - ε ( {y}_{t} - {\hat{q}}_{t}^{{α}_{i + 1}} ) ] -\end{matrix} \\ \{ {A}_{t}^{i} [ {( {\hat{q}}_{t}^{{α}_{i + 1}} )}^{2} - {( {\hat{q}}_{t}^{{α}_{i}} )}^{2} ] + 2 {B}_{t}^{i} ( {\hat{q}}_{t}^{{α}_{i + 1}} - {\hat{q}}_{t}^{{α}_{i}} ) \} [ 1 - ε ( {y}_{t} - {\hat{q}}_{t}^{{α}_{i}} ) ]\end{matrix} \} \qquad ( 28 )$$

then, combining formula (18) and formula (28), the CRPS in formula (11) can be re-expressed as formula (29):

$$( 29 )$$

$${S}_{CRPS} ( \hat{Q} , Y ) = \frac{1}{T} {\sum }_{t = 1}^{T} \{ 1 - {y}_{t} + {\sum }_{i = 0}^{r} \{ \begin{matrix}\begin{matrix}\begin{matrix}\frac{{( {A}_{t}^{i} {\hat{q}}_{t}^{{α}_{i + 1}} + {B}_{t}^{i} )}^{3}}{3 {A}_{t}^{i}} - \frac{{( {A}_{t}^{i} {\hat{q}}_{t}^{{α}_{i}} + {B}_{t}^{i} )}^{3}}{3 {A}_{t}^{i}} - \\ \{ {A}_{t}^{i} [ {( {\hat{q}}_{t}^{{α}_{i + 1}} )}^{2} - {y}_{t}^{2} ] + 2 {B}_{t}^{i} ( {\hat{q}}_{t}^{{α}_{i + 1}} - {y}_{t} ) \}\end{matrix} \\ ε ( {y}_{t} - {\hat{q}}_{t}^{{α}_{i}} ) [ 1 - ε ( {y}_{t} - {\hat{q}}_{t}^{{α}_{i + 1}} ) ] -\end{matrix} \\ \begin{matrix}\{ {A}_{t}^{i} [ {( {\hat{q}}_{t}^{{α}_{i + 1}} )}^{2} - {( {\hat{q}}_{t}^{{α}_{i}} )}^{2} ] + \\ 2 {B}_{t}^{i} ( {\hat{q}}_{t}^{{α}_{i + 1}} - {\hat{q}}_{t}^{{α}_{i}} ) \} [ 1 - ε ( {y}_{t} - {\hat{q}}_{t}^{{α}_{i}} ) ]\end{matrix}\end{matrix} \} \}$$

the expression of CRPS in formula (29) is equivalent to that in formula (3), and it is derivable, so it can be trained as a loss function.
S22, using the transformed derivable CRPS as a loss function to train WQPMMSA,
taking the CRPS in formula (29) as the loss function for training WQPMMSA, the training of WQPMMSA is abstracted as the following optimization problem:

$$min {𝒮}_{CRPS} ( \hat{Q} , Y ) \qquad ( 30 )$$

$$s . t . {\hat{q}}_{t}^{{α}_{i}} - {\hat{q}}_{t}^{{α}_{i + 1}} < 0 , i = 0 , 1 , … , r , t = 1 , 2 , … , T$$

constraint condition: ∀t, \hat{q}ₜ^{α}^{₀}=0 and \hat{q}ₜ^{α}^{ᵣ₊₁}=1, where formula (30) is implemented by a Double Gradient Descent algorithm; firstly, the Lagrangian function [symbol] _{θ,λ} is defined as:

$${ℒ}_{θ , λ} = {𝒮}_{CRPS} ( Q , Y ) + {\sum }_{t = 1}^{T} {\sum }_{i = 0}^{r} {λ}_{t}^{i} ( {\hat{q}}_{t}^{{α}_{i}} - {\hat{q}}_{t}^{{α}_{i + 1}} ) \qquad ( 31 )$$

constraint condition, λₜⁱ≥0, in the above formula, θ is a parameter set of the neural network, and λ is a Lagrange multiplier, then, using the double gradient descent algorithm and using [symbol] _{θ,λ} as a direct loss function to train WQPMMSA, θ and λₜⁱ are updated alternately in the double gradient descent algorithm for the training of WQPMMSA.

Therefore, the invention has the following beneficial effects:

1. The wind power generation quantile prediction method based on machine mental model and self-attention (WQPMMSA) is proposed, which has the following advantages. (1) The machine mental model is used as the basic framework of WQPMMSA, which imitates the mechanism of human cognitive decision-making and can effectively balance the seasonal power generation rules (long-term information) and intraday power generation trend (short-term information). (2) The self-attention layer reduces a long-term forgetting of WQPMMSA. (3) The sum CRPS is used as the loss function to make WQPMMSA approach the optimal quantile prediction results with the highest efficiency.

2. The self-attention is used to replace the recurrent neural network in the original machine mental model, so as to effectively establish a statistical relationship between the seasonal power generation rules and the intraday power generation trend, and reduce the long-term forgetting of the original machine mental theory.

3. The CRPS in the integral form is transformed into a summation form so that WQPMMSA approaches the optimal quantile prediction result with the highest efficiency.

The following is a further detailed description of the technical solution of the invention through drawings and implementation examples.

### BRIEF DESCRIPTION OF THE DRAWINGS

FIGURE is a frame diagram of the WQPMMSA of the invention.

### DETAILED DESCRIPTION OF THE EMBODIMENTS

The following will further describe the invention in combination with the attached diagram. It should be noted that this embodiment gives a detailed implementation method and specific operation process based on this technical solution, but the protection scope of the invention is not limited to this embodiment.

FIGURE is the frame diagram of WQPMMSA of the invention, as shown in FIGURE, the wind power generation quantile prediction method based on machine mental model and self-attention (WQPMMSA) includes the following steps:
S1, constructing a basic architecture of WQPMMSA;
S11, quantile prediction problem description and mathematical expression;

Preferably, Step S11 includes the following steps specifically:
S11, quantile prediction problem description and mathematical expression
the given training data is {(xₜ,yₜ)}ₜ₌₁^{T}, where t is a timestamp, T is a coverage period, xₜ is an explanatory variable of the quantile prediction of wind power generation (such as the statistics of the seasonal power generation rules, the current wind field output trend, the weather prediction information, etc.), yₜ is a target variable, such as the power generation of a wind farm at time t; the goal of quantile prediction is to estimate the quantile of the probability distribution of yt+h:

$${x}_{t - D + 1} , {x}_{t - D + 2} , … , {x}_{t} \to [ {q}_{t + h}^{{α}_{1}} , {q}_{t + h}^{{α}_{2}} , … , {q}_{t + h}^{{α}_{r}} ] \qquad ( 1 )$$

among them, qₜ₊ₕ^{a} is a quantile when the cumulative probability of the probability distribution corresponding to yₜ₊ₕ is a, r is a number of sampled a, and D is a lag interval of the prediction task; if \hat{q}ₜ₊ₕ^{a} is used to represent the prediction or estimation of qₜ₊ₕ^{a}, then all the quantiles of prediction at time t can be written as \hat{q}ₜ₊ₕ=[\hat{q}ₜ₊ₕ^{a}^{₁}, \hat{q}ₜ₊ₕ^{a}^{₂}, . . . , \hat{q}ₜ₊ₕ^{a}^{ᵣ}]; then, the predicted quantiles at all times can be combined to represented as \hat{Q}=[\hat{q}₁, \hat{q}₂ . . . , \hat{q}_{T}], \hat{Q}ϵR^{(T×r)}, or all observations of the predicted target variable yₜ can be combined as Y=[y₁, y₂, . . . , y_{T}].
S121, establishing three networks of seasonal rules network, intraday trend network, and prediction network in WQPMMSA; the seasonal rules network aims to obtain the seasonal rules characteristics of wind farm output, the intraday trend network aims to estimate the intraday trend of wind power in recent hours; the prediction network is used to predict the quantile of wind power distribution after 1 hour;
the three parts of WQPMMSA, namely the seasonal rules network, the intraday trend network, and the prediction network, are all composed of a self-attention layer. Self-attention is an effective method to alleviate the long-term forgetting of neural networks, and its high parallelism brings high time efficiency, the core idea of self-attention is to use the mutual attention of input samples to re-express all input samples, assuming that the input sample matrix is X=[x₁, x₂, . . . , x_{N}]^{T}, where N is the total number of samples, the self-attention is calculated as follows:

$$Z = softmax ( \frac{Q \cdot {K}^{T}}{\sqrt{{d}_{k}}} ) \cdot V \qquad ( 2 )$$

among them:

$$Q = X \cdot {W}^{Q} , K = X \cdot {W}^{K} , V = X \cdot {W}^{V}$$

W^{Q}, W^{K}, W^{V} in the above formula are trainable weight matrices; Q, K, and V are query matrix, key matrix, and value matrix respectively; dₖ is a dimension of each row in Q; Z is an output of the self-attention layer, that is, the re-expression of each sample;
S122, constructing two feature codes in WQPMMSA: seasonal rules coding and intraday trend coding; the seasonal rules coding aims to summarize the statistical law of wind field output with seasonal variations from daily power generation curves in the past three months, the intraday trend coding aims to capture the current trend of wind power output from the recent power generation;
S123, combining seasonal rules coding, intraday trend coding, and time periodic information by WQPMMSA, and then outputting the quantile prediction value of wind power generation by predicting the network.
S2, training and prediction of WQPMMSA;
S21, using Continuous Ranked Probability Score (CRPS) as an evaluation index of WQPMMSA prediction results, and is transformed into a derivable form by derivation.

Preferably, Step S21 includes the following steps specifically:
S21, adopting Continuous Ranked Probability Score(CRPS) as an evaluation index of WQPMMSA prediction results, and transforming it into a derivable form by derivation;
CRPS is a comprehensive quantile evaluation index, which takes into account the reliability and sharpness of the predicted quantile, it is defined as follows:

$${𝒮}_{C R P S} ( \hat{Q} , Y ) = \frac{1}{T} {\sum }_{t = 1}^{T} {\int }_{- ∞}^{+ ∞} {[ {\hat{F}}_{t} ( p ) - ε ( p - {y}_{t} ) ]}^{2} d p \qquad ( 3 )$$

among them, \ddot{F}t(⋅) is obtained by linear interpolation of {(\hat{q}ₜ^{a}^{ᵢ}, aᵢ)}ᵢ₌₀^{r+1} (where \hat{q}ₜ^{a}^{ᵣ₊₁} and \hat{q}ₜ^{a}^{₀} represent the upper and lower bounds of ye, respectively, and a₀=0, aᵣ₊₁=1), ε(⋅) is a step function defined as follows:

$$( x ) = \{ \begin{matrix}1 , if x \geq 0 \\ 0 , if x < 0\end{matrix} \qquad ( 4 )$$

after regularizing yₜ to [0, 1], formula (3) is simplified as follows:

$${𝒮}_{CRPS} ( \hat{Q} , Y ) = \frac{1}{T} {\sum }_{t = 1}^{T} {\int }_{0}^{1} {[ {\hat{F}}_{t} ( p ) - ε ( p - {y}_{t} ) ]}^{2} dp \qquad ( 5 )$$

proving that the CRPS integral in formula (5) is equivalently rewritten as the following derivable form:

$${𝒮}_{C R P S} ( \hat{Q} , Y ) = \frac{1}{T} {\sum }_{t = 1}^{T} ( {C}_{t} + 1 - {y}_{t} ) ) \qquad ( 6 )$$

among them:

$${C}_{t} = {\sum }_{i = 0}^{r} \{ \begin{matrix}\frac{{( {A}_{t}^{i} \cdot {\hat{q}}_{t}^{{α}_{i + 1}} + {B}_{t}^{i} )}^{3}}{3 {A}_{t}^{i}} - \frac{{( {A}_{t}^{i} \cdot {\hat{q}}_{t}^{{α}_{i}} + {B}_{t}^{i} )}^{3}}{3 {A}_{t}^{i}} \\ \begin{matrix}\{ {A}_{t}^{i} [ {( {\hat{q}}_{t}^{{α}_{i + 1}} )}^{2} - {y}_{t}^{2} ] + 2 {B}_{t}^{i} ( {\hat{q}}_{t}^{{α}_{i + 1}} - {y}_{t} ) \} \cdot {I}_{[ {\hat{q}}_{t}^{{α}_{i}} , {\hat{q}}_{t}^{{α}_{i + 1}} )} ( {y}_{y} ) - \\ \{ {A}_{t}^{i} [ {( {\hat{q}}_{t}^{{α}_{i + 1}} )}^{2} - {( {\hat{q}}_{t}^{{α}_{i}} )}^{2} ] + 2 {B}_{t}^{i} ( {\hat{q}}_{t}^{{α}_{i + 1}} - {\hat{q}}_{t}^{{α}_{i}} ) \} \cdot [ 1 - ε ( {y}_{t} - {\hat{q}}_{t}^{{α}_{i}} ) ]\end{matrix}\end{matrix} \}$$

$${A}_{t}^{i} = \frac{{α}_{i + 1} - {α}_{i}}{{\hat{q}}_{t}^{{α}_{i + 1}} - {\hat{q}}_{t}^{{α}_{i}}} , {B}_{t}^{i} = \frac{{α}_{i} \cdot {\hat{q}}_{t}^{{α}_{i + 1}} - {α}_{i + 1} \cdot {\hat{q}}_{t}^{{α}_{i}}}{{\hat{q}}_{t}^{{α}_{i + 1}} - {\hat{q}}_{t}^{{α}_{i}}}$$

$${I}_{[ {\hat{q}}_{t}^{{α}_{i}} , {\hat{q}}_{t}^{{α}_{i + 1}} )} ( {y}_{t} ) = ε ( {y}_{t} - {\hat{q}}_{t}^{{α}_{i}} ) \cdot [ 1 - ε ( {y}_{t} - {\hat{q}}_{t}^{{α}_{i + 1}} ) ]$$

the proof of the above conclusion is as follows:
if the given prediction quantile is:

$$( {\hat{q}}_{t}^{{α}_{i}} , {α}_{i} ) , i = 0 , 1 , … , r + 1 \qquad ( 10 )$$

among them, a₀=\hat{q}ₜ^{a}^{₀}=0, aᵣ₊₁=\hat{q}ₜ^{a}^{ᵣ₊₁}=1.0
then:

$${𝒮}_{CRPS} ( \hat{Q} , Y ) = \frac{1}{T} {\sum }_{t = 1}^{T} {\int }_{0}^{1} {[ {F}_{t} ( p ) - ε ( p - {y}_{t} ) ]}^{2} dp \qquad ( 11 )$$

where Fₜ(p) is obtained by linear interpolation on (\hat{q}ₜ^{α}^{ᵢ}, αᵢ)ᵢ₌₀^{r+1};
the line segments determined by (\hat{q}ₜ^{α}^{ᵢ}, αᵢ) and (\hat{q}ₜ^{α}^{ᵢ₊₁}, αᵢ₊₁) can be expressed by the following formula:

$$z = {A}_{t}^{i} \cdot p + {B}_{t}^{i} \qquad ( 12 )$$

$${A}_{t}^{i} = \frac{{α}_{i + 1} - {α}_{i}}{{\hat{q}}_{t}^{{α}_{i + 1}} - {\hat{q}}_{t}^{{α}_{i}}} , {B}_{t}^{i} = \frac{{α}_{i} \cdot {\hat{q}}_{t}^{{α}_{i + 1}} - {α}_{i + 1} \cdot {\hat{q}}_{t}^{{α}_{i}}}{{\hat{q}}_{t}^{{α}_{i + 1}} - {\hat{q}}_{t}^{{α}_{i}}} \qquad ( 13 )$$

since Fₜ(p) is piecewise, its feasible region can be divided into the following mutually exclusive parts:

$$[ 0 , 1 ] ⇔ [ {\hat{q}}_{t}^{{α}_{0}} , {\hat{q}}_{t}^{{α}_{1}} ) ⋃ … ⋃ [ {\hat{q}}_{t}^{{α}_{i}} , {\hat{q}}_{t}^{{α}_{i + 1}} ) ⋃ … [ {\hat{q}}_{t}^{{α}_{r}} , {\hat{q}}_{t}^{{α}_{r + 1}} ) ⋃ {\hat{q}}_{t}^{{α}_{r + 1}} \qquad ( 14 )$$

Fₜ(p) is continuously derivable in each segment except the last isolated point \hat{q}ₜ^{a}^{ᵣ₊₁}; an indicator function corresponding to the probability interval [\hat{q}ₜ^{a}^{ᵢ}, \hat{q}ₜ^{a}^{ᵢ₊₁}) can be transformed into:

$$p ∈ [ {\hat{q}}_{t}^{{α}_{i}} , {\hat{q}}_{t}^{{α}_{i + 1}} ) \qquad ( 15 )$$

$$⇒ p ∈ [ {\hat{q}}_{t}^{{α}_{i}} , + ∞ ) ⋂ ( - ∞ , {\hat{q}}_{t}^{{α}_{i + 1}} )$$

$$⇒ ε ( p - {\hat{q}}_{t}^{{α}_{i}} ) = 1 and 1 - ε ( p - {\hat{q}}_{t}^{{α}_{i + 1}} ) = 1$$

$$⇔ ε ( p - {\hat{q}}_{t}^{{α}_{i}} ) \cdot [ 1 - ε ( p - {\hat{q}}_{t}^{{α}_{i + 1}} ) ] = 1$$

the indicator function corresponding to the last boundary point \hat{q}ₜ^{a}^{ᵣ₊₁} can be transformed into:

$$p = {\hat{q}}_{t}^{{α}_{r + 1}} \qquad ( 16 )$$

$$⇒ p ∈ [ {\hat{q}}_{t}^{{α}_{r + 1}} , {\hat{q}}_{t}^{{α}_{r + 1}} ]$$

$$⇒ p ∈ [ {\hat{q}}_{t}^{{α}_{r + 1}} , + ∞ ) ⋂ ( - ∞ , {\hat{q}}_{t}^{{α}_{r + 1}} ]$$

$$⇒ ε ( p - {\hat{q}}_{t}^{{α}_{r + 1}} ) = 1 and ε ( {\hat{q}}_{t}^{{α}_{r + 1}} - p ) = 1$$

$$⇔ ε ( p - {\hat{q}}_{t}^{{α}_{r + 1}} ) \cdot ε ( {\hat{q}}_{t}^{{α}_{r + 1}} - p ) = 1$$

$$⇔ ε ( p - 1 ) \cdot ε ( 1 - p ) = 1$$

accordingly, Fₜ(p) can be re-expressed as:

$${F}_{t} ( p ) = {\sum }_{i = 0}^{r} \{ ε ( p - {\hat{q}}_{t}^{{α}_{i}} ) \cdot [ 1 - ε ( p - {\hat{q}}_{t}^{{α}_{i + 1}} ) ] \cdot ( {A}_{t}^{i} \cdot p + {B}_{t}^{i} ) \} + ε ( p - 1 ) \cdot ε ( 1 - p ) \qquad ( 17 )$$

combining formula (11) and formula (17) to obtain formula (18):

$${\int }_{0}^{1} {[ {F}_{t} ( p ) - ε ( p - {y}_{t} ) ]}^{2} dp = {\int }_{0}^{1} {\{ {\sum }_{i = 0}^{r} \{ ε ( p - {\hat{q}}_{t}^{{α}_{i}} ) \cdot [ 1 - ε ( p - {\hat{q}}_{t}^{{α}_{i + 1}} ) ] \cdot ( {A}_{t}^{i} \cdot p + {B}_{t}^{i} ) \} + ε ( p - 1 ) \cdot ε ( 1 - p ) - ε ( p - {y}_{t} ) \}}^{2} dp = {\sum }_{i = 0}^{r} {\int }_{0}^{1} \{ {{ε}^{2} ( p - {\hat{q}}_{t}^{{α}_{i}} ) [ 1 - ε ( p - {\hat{q}}_{t}^{{α}_{i + 1}} ) ]}^{2} {( {A}_{t}^{i} p + {B}_{t}^{i} )}^{2} \} dp + {\int }_{0}^{1} {ε}^{2} ( p - 1 ) {ε}^{2} ( 1 - p ) dp + {\int }_{0}^{1} {ε}^{2} ( p - {y}_{t} ) dp + 2 {\sum }_{i = 0}^{r} {\sum }_{j = 0 , j \neq 1}^{r} {\int }_{0}^{1} \{ ε ( p - {\hat{q}}_{t}^{{α}_{i}} ) [ 1 - ε ( p - {\hat{q}}_{t}^{{α}_{i + 1}} ) ] ( {A}_{t}^{i} \cdot p + {B}_{t}^{i} ) ε ( p - {\hat{q}}_{t}^{{α}_{i}} ) [ 1 - ε ( p - {\hat{q}}_{t}^{{α}_{j + 1}} ) ] ( {A}_{t}^{j} \cdot p + {B}_{t}^{j} ) dp + {\sum }_{i = 0}^{r} {\int }_{0}^{1} \{ ε ( p - {\hat{q}}_{t}^{{α}_{i}} ) \cdot [ 1 - ε ( p - {\hat{q}}_{t}^{{α}_{i + 1}} ) ] \cdot ( {A}_{t}^{i} \cdot p + {B}_{t}^{i} ) \cdot ε ( p - 1 ) \cdot ε ( 1 - p ) \} - {\sum }_{i = 0}^{r} {\int }_{0}^{1} \{ ε ( p - {\hat{q}}_{t}^{{α}_{i}} ) \cdot [ 1 - ε ( p - {\hat{q}}_{t}^{{α}_{i + 1}} ) ] \cdot ( {A}_{t}^{i} \cdot p + {B}_{t}^{i} ) \cdot ε ( p - {y}_{t} ) \} dp - 2 {\int }_{0}^{1} ε ( p - 1 ) \cdot ε ( 1 - p ) ε ( p - {y}_{t} ) dp \qquad ( 18 )$$

then determining the following lemmas as the basis for further derivation:

$$Lemma 1 : for any x ∈ R \qquad ( 19 )$$

$${ε}^{2} ( x ) = ε ( x ) {and [ 1 - ε ( x ) ]}^{2} = 1 - ε ( x )$$

$$Lemma 2 : for any x ∈ R , and i \neq j \qquad ( 20 )$$

$$ε ( p - {q}_{t}^{⋀ α i} ) \cdot [ 1 - ε ( p - {q}_{t}^{⋀ α i + 1} ) ] \cdot ε ( p - {q}_{t}^{⋀ α j} ) \cdot [ 1 - ε ( p - {q}_{t}^{⋀ α j + 1} ) ] = 0$$

Lemma 3: for any finite function f(x) on R, it has the following result:

$${\int }_{0}^{1} ε ( p - 1 ) \cdot [ 1 - ε ( p - 1 ) ] \cdot f ( p ) dp = 0 \qquad ( 21 )$$

it is proved in the following:

$${\int }_{0}^{1} ε ( p - 1 ) \cdot ε ( 1 - p ) \cdot f ( p ) dp = {lim}_{u \to {1}^{-}} {\int }_{0}^{u} ε ( p - 1 ) \cdot ε ( 1 - p ) \cdot f ( p ) dp = 0 + {lim}_{u \to {1}^{-}} {\int }_{u}^{1} ε ( p - 1 ) \cdot ε ( 1 - p ) \cdot f ( p ) dp = 0 + {lim}_{u \to {1}^{-}} f ( u ) \cdot ( 1 - u ) = f ( 1 ) \cdot 0 = 0 \qquad ( 22 )$$

combining with formula (19), formula (20), and formula (21), formula (18) is simplified as follows:

$${\int }_{0}^{1} {\{ \begin{matrix}{\sum }_{i = 0}^{r} \{ ε ( p - {\hat{q}}_{t}^{{α}_{i}} ) \cdot [ 1 - ε ( p - {\hat{q}}_{t}^{{α}_{i + 1}} ) ] \cdot ( {A}_{t}^{i} \cdot p + {B}_{t}^{i} ) \} \\ + ε ( p - 1 ) \cdot ε ( 1 - p ) - ε ) p - {y}_{t} )\end{matrix} \}}^{2} dp = {\sum }_{i = 0}^{r} \{ \begin{matrix}{\int }_{0}^{1} \{ ε ( p - {\hat{q}}_{t}^{{α}_{i}} ) \cdot [ 1 - ε ( p - {\hat{q}}_{t}^{{α}_{i + 1}} ) ] \cdot {( {A}_{t}^{i} \cdot p + {B}_{t}^{i} )}^{2} \} dp \\ - 2 {\int }_{0}^{1} \{ ε ( p - {\hat{q}}_{t}^{{α}_{i}} ) \cdot [ 1 - ε ( p - {\hat{q}}_{t}^{{α}_{i + 1}} ) ] \cdot ( {A}_{t}^{i} \cdot p + {B}_{t}^{i} ) \cdot ε ( p - {y}_{t} ) \} dp\end{matrix} \} + 1 - {y}_{t} \qquad ( 23 )$$

Because ∫₀¹{ε(p−\hat{q}ₜ^{a}^{ᵢ})·[1−ε(p−\hat{q}ₜ^{a}^{ᵢ₊₁})]·(Aₜⁱ·p+Bₜⁱ)²}dp is equal to the area of curve zᵢ=(Aₜⁱ·p+Bₜⁱ)² between p=\hat{q}ₜ ^{α}^{ᵢ} and p=\hat{q}ₜ^{α}^{ᵢ₊₁}, therefore:

$${\int }_{0}^{1} \{ ε ( p - {\hat{q}}_{t}^{{α}_{i}} ) \cdot [ 1 - ε ( p - {\hat{q}}_{t}^{{α}_{i + 1}} ) ] \cdot {( {A}_{t}^{i} \cdot p + {B}_{t}^{i} )}^{2} \} dp = \frac{{( {A}_{t}^{i} \cdot {\hat{q}}_{t}^{{α}_{i + 1}} + {B}_{t}^{i} )}^{3}}{3 {A}_{t}^{i}} - \frac{{( {A}_{t}^{i} \cdot {\hat{q}}_{t}^{{α}_{i}} + {B}_{t}^{i} )}^{3}}{3 {A}_{t}^{i}} \qquad ( 24 )$$

$$however , {\int }_{0}^{1} \{ ε ( p - {\hat{q}}_{t}^{{α}_{i}} ) \cdot [ 1 - ε ( p - {\hat{q}}_{t}^{{α}_{i + 1}} ) ] \cdot ( {A}_{t}^{i} \cdot p + {B}_{t}^{i} ) \cdot ε ( p - {y}_{t} ) \} dp$$

can be equivalently converted into the following three cases:

$$\begin{matrix}( A ) & \\ when {\hat{q}}_{t}^{{α}_{i}} < {y}_{t} , {\hat{q}}_{t}^{{α}_{i + 1}} \leq {y}_{t} , namely ε ( {y}_{t} - {\hat{q}}_{t}^{{α}_{i + 1}} ) = 1 , \text{} {\int }_{0}^{1} \{ ε ( p - {\hat{q}}_{t}^{{α}_{i}} ) \cdot [ 1 - ε ( p - {\hat{q}}_{t}^{{α}_{i + 1}} ) ] \cdot ( {A}_{t}^{i} \cdot p + {B}_{t}^{i} ) \cdot ε ( p - {y}_{t} ) \} dp = 0 & ( 25 )\end{matrix}$$

$$\begin{matrix}( B ) & \\ when {\hat{q}}_{t}^{{α}_{i}} \leq {y}_{t} < {\hat{q}}_{t}^{{α}_{i + 1}} , namely ε ( {y}_{t} - {\hat{q}}_{t}^{{α}_{i}} ) \cdot [ 1 - ε ( {y}_{t} - {\hat{q}}_{t}^{{α}_{i + 1}} ) ] = 1 {\int }_{0}^{1} \{ ε ( p - {\hat{q}}_{t}^{{α}_{i}} ) \cdot [ 1 - ε ( p - {\hat{q}}_{t}^{{α}_{i + 1}} ) ] \cdot ( {A}_{t}^{i} \cdot p + {B}_{t}^{i} ) \cdot ε ( p - {y}_{t} ) \} dp = \frac{1}{2} {A}_{t}^{i} [ {( {\hat{q}}_{t}^{{α}_{i + 1}} )}^{2} - {{y}_{t}}^{2} ] + {B}_{t}^{i} ( {\hat{q}}_{t}^{{α}_{i + 1}} - {y}_{t} ) & ( 26 )\end{matrix}$$

$$\begin{matrix}( C ) & \\ when {y}_{t} < {\hat{q}}_{t}^{{α}_{i}} , namely [ 1 - ε ( {y}_{t} - {\hat{q}}_{t}^{{α}_{i}} ) ] = 1 {\int }_{0}^{1} \{ ε ( p - {\hat{q}}_{t}^{{α}_{i}} ) \cdot [ 1 - ε ( p - {\hat{q}}_{t}^{{α}_{i + 1}} ) ] \cdot ( {A}_{t}^{i} \cdot p + {B}_{t}^{i} ) \cdot ε ( p - {y}_{t} ) \} dp = \frac{1}{2} {A}_{t}^{i} [ {( {\hat{q}}_{t}^{{α}_{i + 1}} )}^{2} - {( {\hat{q}}_{t}^{{α}_{i}} )}^{2} ] + {B}_{t}^{i} ( {\hat{q}}_{t}^{{α}_{i + 1}} - {\hat{q}}_{t}^{{α}_{i}} ) & ( 27 )\end{matrix}$$

Combining formula (23), formula (24), formula (25), formula (26) and formula (27) to obtain formula (28):

$$( 28 )$$

$${\int }_{0}^{1} {\{ {\sum }_{i = 0}^{r} \{ ε ( p - {\hat{q}}_{t}^{{α}_{i}} ) [ 1 - ε ( p - {\hat{q}}_{t}^{{α}_{i + 1}} ) ] ( {A}_{t}^{i} p + {B}_{t}^{i} ) \} + ε ( p - 1 ) ε ( 1 - p ) - ε ( p - {y}_{t} ) \}}^{2} dp = 1 - {y}_{t} + {\sum }_{i = 0}^{r} \{ \begin{matrix}\frac{{( {A}_{t}^{i} {\hat{q}}_{t}^{{α}_{i + 1}} + {B}_{t}^{i} )}^{3}}{3 {A}_{t}^{i}} - \frac{{( {A}_{t}^{i} {\hat{q}}_{t}^{{α}_{i}} + {B}_{t}^{i} )}^{3}}{3 {A}_{t}^{i}} \\ - \{ {A}_{t}^{i} [ {( {\hat{q}}_{t}^{{α}_{i + 1}} )}^{2} - {{y}_{t}}^{2} ] + 2 {B}_{t}^{i} ( {\hat{q}}_{t}^{{α}_{i + 1}} - {y}_{t} ) \} ε ( {y}_{t} - {\hat{q}}_{t}^{{α}_{i}} ) [ 1 - ε ( {y}_{t} - {\hat{q}}_{t}^{{α}_{i + 1}} ) ] \\ - \{ {A}_{t}^{i} [ {( {\hat{q}}_{t}^{{α}_{i + 1}} )}^{2} - {( {\hat{q}}_{t}^{{α}_{i}} )}^{2} ] + 2 {B}_{t}^{i} ( {\hat{q}}_{t}^{{α}_{i + 1}} - {\hat{q}}_{t}^{{α}_{i}} ) \} [ 1 - ε ( {y}_{t} - {\hat{q}}_{t}^{{α}_{i}} ) ]\end{matrix} \}$$

then, combining formula (18) and formula (28), the CRPS in formula (11) can be re-expressed as formula (29):

$$( 29 )$$

$${𝒮}_{CRPS} ( \hat{Q} , Y ) = \frac{1}{T} {\sum }_{t = 1}^{T} \{ 1 - {y}_{t} + {\sum }_{i = 0}^{r} \{ \begin{matrix}\frac{{( {A}_{t}^{i} {\hat{q}}_{t}^{{α}_{i + 1}} + {B}_{t}^{i} )}^{3}}{3 {A}_{t}^{i}} - \frac{{( {A}_{t}^{i} {\hat{q}}_{t}^{{α}_{i}} + {B}_{t}^{i} )}^{3}}{3 {A}_{t}^{i}} \\ - \{ {A}_{t}^{i} [ {( {\hat{q}}_{t}^{{α}_{i + 1}} )}^{2} - {{y}_{t}}^{2} ] + 2 {B}_{t}^{i} ( {\hat{q}}_{t}^{{α}_{i + 1}} - {y}_{t} ) \} ε ( {y}_{t} - {\hat{q}}_{t}^{{α}_{i}} ) [ 1 - ε ( {y}_{t} - {\hat{q}}_{t}^{{α}_{i + 1}} ) ] \\ - \{ {A}_{t}^{i} [ {( {\hat{q}}_{t}^{{α}_{i + 1}} )}^{2} - {( {\hat{q}}_{t}^{{α}_{i}} )}^{2} ] + 2 {B}_{t}^{i} ( {\hat{q}}_{t}^{{α}_{i + 1}} - {\hat{q}}_{t}^{{α}_{i}} ) \} [ 1 - ε ( {y}_{t} - {\hat{q}}_{t}^{{α}_{i}} ) ]\end{matrix} \} \}$$

the expression of CRPS in formula (29) is equivalent to that in formula (3), and it is derivable, so it can be trained as a loss function.
S22, using the transformed derivable CRPS as a loss function to train WQPMMSA;
taking the CRPS in formula (29) as the loss function for training WQPMMSA, the training of WQPMMSA is abstracted as the following optimization problem:

$${min}_{θ} {𝒮}_{CRPS} ( \hat{Q} , Y ) \qquad ( 30 )$$

$$s . t . {\hat{q}}_{t}^{{α}_{i}} - {\hat{q}}_{t}^{{α}_{i + 1}} < 0 , i = 0 , 1 , … , r , t = 1 , 2 , … , T$$

constraint condition: ∀t, \hat{q}ₜ^{a}^{₀}=0 and \hat{q}ₜ^{a}^{ᵣ₊₁}=1, where formula (30) is implemented by a double gradient descent algorithm; firstly, the Lagrangian function [symbol] _{θ, λ} is defined as:

$${ℒ}_{θ , λ} = {𝒮}_{CRPS} ( \hat{Q} , Y ) + {\sum }_{t = 1}^{T} {\sum }_{i = 0}^{r} {λ}_{t}^{i} ( {\hat{q}}_{t}^{{α}_{i}} - {\hat{q}}_{t}^{{α}_{i + 1}} ) \qquad ( 31 )$$

constraint condition, λₜⁱ≥0, in the above formula, θ is a parameter set of the neural network, and λ is a Lagrange multiplier, then, using the double gradient descent algorithm and using [symbol] _{θ,λ} as the direct loss function to train WQPMMSA, θ and λₜⁱ are updated alternately in the double gradient descent algorithm for the training of WQPMMSA.
S22, using the transformed derivable CRPS as a loss function to train WQPMMSA;
S23, simulating the human psychological decision-making mechanism to predict the quantile of wind power generation by WQPMMSA using the machine mental model.

The invention proposes an effective solution to apply the machine mental model and self-attention mechanism to the quantile prediction of wind power generation, namely WQPMMSA. WQPMMSA is superior to the most advanced parametric and nonparametric quantile prediction models in terms of reliability and sharpness of prediction results. The advantages of WQPMMSA are as follows: (1) WQPMMSA is based on a machine mental model, which imitates the process of human cognitive decision-making, it can effectively balance the seasonal power generation rules and the short-term intraday power generation trend, making it superior to the existing deep learning prediction model. (2) The advantages of the self-attention layer in WQPMMSA in alleviating long-term forgetting and disaster forgetting to give it high accuracy. (3) The CRPS in the integral form is transformed into the summation form so that WQPMMSA can approach the optimal quantile prediction result with the highest efficiency. WQPMMSA can realize accurate probability prediction of wind power generation, which is conducive to the economic operation of the energy system and improves the social welfare of a low-carbon future.

Finally, it should be explained that the above embodiments are only used to explain the technical solution of the invention rather than restrict it. Although the invention is described in detail with reference to the better embodiment, ordinary technical personnel in this field should understand that they can still modify or replace the technical solution of the invention, and these modifications or equivalent substitutions cannot make the modified technical solution out of the spirit and scope of the technical solution of the invention.

What is claimed is:

1. A wind power generation quantile prediction method based on machine mental model and self-attention (WQPMMSA), comprising the following steps:
S1: constructing a basic architecture of WQPMMSA;
S11: performing quantile prediction problem description and mathematical expression;
S12: constructing a machine mental model as the basic architecture of WQPMMSA, and then encoding seasonal power generation rules and short-term intraday power generation trend into WQPMMSA as input information of the wind power quantile prediction method, and integrating a self-attention mechanism into WQPMMSA as a link to connect each code and vector; and
S2: performing training and prediction of WQPMMSA;
S21: using Continuous Ranked Probability Score (CRPS) as an evaluation index of WQPMMSA prediction results, and transforming CRPS into a derivable form by derivation;
S22: using a transformed derivable CRPS as a loss function to train WQPMMSA; and
S23: simulating a human psychological decision-making mechanism to predict a quantile of wind power generation by WQPMMSA using the machine mental model.

2. The wind power generation quantile prediction method based on machine mental model and self-attention according to claim 1, wherein step S11 comprises the following steps:
S11: performing quantile prediction problem description and mathematical expression:
the given training data is {(xₜ,yₜ)}ₜ₌₁^{T}, wherein t is a timestamp, T is a coverage period, xₜ is an explanatory variable of the quantile prediction of wind power generation (such as statistics of the seasonal power generation rules, a current wind field output trend, a weather prediction information, etc.), yₜ is a target variable, such as the power generation of a wind farm at time t; a goal of quantile prediction is to estimate the quantile of the probability distribution of yₜ₊ₕ:
$${x}_{t - D + 1} , {x}_{t - D + 2} , … , {x}_{t} \to [ {q}_{t + h}^{{α}_{1}} , {q}_{t + h}^{{α}_{2}} , … , {q}_{t + h}^{{α}_{r}} ] \qquad ( 1 )$$
wherein qₜ₊ₕ^{a} is a quantile when a cumulative probability of the probability distribution corresponding to yₜ₊ₕ is a, r is a number of sampled a, and D is a lag interval of the prediction task, if \hat{q}ₜ₊ₕ^{a} is used to represent the prediction or estimation of qₜ₊ₕ^{a}, then all the quantiles of prediction at time t are written as \hat{q}ₜ₊ₕ=[\hat{q}ₜ₊ₕ^{a} ^{₁}, \hat{q}ₜ₊ₕ^{a} ^{₂}, . . . , \hat{q}ₜ₊ₕ^{a} ^{ᵣ}; then, the predicted quantiles at all times are combined to be represented as \hat{Q}=[\hat{q}₁, \hat{q}₂ . . . , \hat{q}_{T}], \hat{Q}ϵR^{(T×r)}, or all observations of the predicted target variable yₜ are combined as Y=[y₁, y₂, . . . , y_{T}].

3. The wind power generation quantile prediction method based on machine mental model and self-attention according to claim 2, wherein step S12 comprises the following steps:
S121: establishing three networks of seasonal rules network, intraday trend network, and prediction network in WQPMMSA; the seasonal rules network aims to obtain seasonal rules characteristics of wind farm output, the intraday trend network aims to estimate an intraday trend of wind power in recent hours; the prediction network is used to predict the quantile of wind power distribution after 1 hour;
the three parts of WQPMMSA, namely the seasonal rules network, the intraday trend network, and the prediction network, are all composed of a self-attention layer; self-attention is an effective method to alleviate a long-term forgetting of neural networks, and a high parallelism of the self-attention brings high time efficiency; a core idea of the self-attention is to use a mutual attention of input samples to re-express all input samples, assuming that an input sample matrix is X=[x₁, x₂, . . . , x_{N}]^{T}, wherein N is a total number of samples, the self-attention is calculated as follows:
$$Z = softmax ( \frac{Q \cdot {K}^{T}}{\sqrt{{d}_{k}}} ) \cdot V \qquad ( 2 )$$
$$wherein$$
$$Q = X \cdot {W}^{Q} , K = X \cdot {W}^{K} , V = X \cdot {W}^{V}$$
W^{Q}, W^{K}, W^{V} in the above formula are trainable weight matrices; Q, K, and V are query matrix, key matrix, and value matrix respectively, dₖ is a dimension of each row in Q; Z is an output of the self-attention layer, that is, a re-expression of each sample;
S122: constructing two feature codes in WQPMMSA: seasonal rules coding and intraday trend coding; the seasonal rules coding aims to summarize the statistical law of wind field output with seasonal variations from daily power generation curves in the past three months, the intraday trend coding aims to capture the current trend of wind power output from the recent power generation; and
S123: combining seasonal rules coding, intraday trend coding, and time periodic information by WQPMMSA and then outputting the quantile prediction value of wind power generation by predicting the network.

4. The wind power generation quantile prediction method based on machine mental model and self-attention according to claim 1, wherein step S21 comprises the following steps:
S21: adopting Continuous Ranked Probability Score (CRPS) as an evaluation index of WQPMMSA prediction results, and transforming CRPS into a derivable form by derivation;
CRPS is a comprehensive quantile evaluation index, wherein CRPS takes into account the reliability and sharpness of the predicted quantile, and CRPS is defined as follows:
$${𝒮}_{CRPS} ( \hat{Q} , Y ) = \frac{1}{T} {\sum }_{t = 1}^{T} {\int }_{- ∞}^{+ ∞} {[ {\hat{F}}_{t} ( p ) - ε ( p - {y}_{t} ) ]}^{2} dp \qquad ( 3 )$$
wherein \hat{F}ₜ(⋅) is obtained by linear interpolation of {(\hat{q}ₜ^{a}^{ᵢ}, aᵢ)}ᵢ₌₀^{r+1} (wherein \hat{q}ₜ^{a}^{ᵣ₊₁} and \hat{q}ₜ^{a}^{₀} represent upper and lower bounds of ye, respectively, and a₀=0, aᵣ₊₁=1), ε(⋅) is a step function defined as follows:
$$ε ( x ) = \{ \begin{matrix}1 , & if x \geq 0 \\ 0 , & if x < 0\end{matrix} \qquad ( 4 )$$
after regularizing yₜ to [0, 1], formula (3) is simplified as follows:
$${𝒮}_{CRPS} ( \hat{Q} , Y ) = \frac{1}{T} {\sum }_{t = 1}^{T} {\int }_{0}^{1} {[ {\hat{F}}_{t} ( p ) - ε ( p - {y}_{t} ) ]}^{2} dp \qquad ( 5 )$$
proving that the CRPS integral in formula (5) is equivalently rewritten as the following derivable form:
$${𝒮}_{CRPS} ( \hat{Q} , Y ) = \frac{1}{T} {\sum }_{t = 1}^{T} ( {C}_{t} + 1 - {y}_{t} ) ) \qquad ( 6 )$$
$$wherein$$
$${C}_{t} = {\sum }_{i = 0}^{r} \{ \begin{matrix}\frac{{( {A}_{t}^{i} \cdot {\hat{q}}_{t}^{{α}_{i + 1}} + {B}_{t}^{i} )}^{3}}{3 {A}_{t}^{i}} - \frac{{( {A}_{t}^{i} \cdot {\hat{q}}_{t}^{{α}_{i}} + {B}_{t}^{i} )}^{3}}{3 {A}_{t}^{i}} \\ \{ {A}_{t}^{i} [ {( {\hat{q}}_{t}^{{α}_{i + 1}} )}^{2} - {{y}_{t}}^{2} ] + 2 {B}_{t}^{i} ( {\hat{q}}_{t}^{{α}_{i + 1}} - {y}_{t} ) \} \cdot {I}_{[ {\hat{q}}_{t}^{{α}_{i}} , {\hat{q}}_{t}^{{α}_{i + 1}} )} ( {y}_{t} ) - \\ \{ {A}_{t}^{i} [ {( {\hat{q}}_{t}^{{α}_{i + 1}} )}^{2} - {( {\hat{q}}_{t}^{{α}_{i}} )}^{2} ] + 2 {B}_{t}^{i} ( {\hat{q}}_{t}^{{α}_{i + 1}} - {\hat{q}}_{t}^{{α}_{i}} ) \} \cdot [ 1 - ε ( {y}_{t} - {\hat{q}}_{t}^{{α}_{i}} ) ]\end{matrix} \} \qquad ( 7 )$$
$${A}_{t}^{i} = \frac{{α}_{i + 1} - {α}_{i}}{{\hat{q}}_{t}^{{α}_{i + 1}} - {\hat{q}}_{t}^{{α}_{i}}} , {B}_{t}^{i} = \frac{{α}_{i} \cdot {\hat{q}}_{t}^{{α}_{i + 1}} - {α}_{i + 1} \cdot {\hat{q}}_{t}^{{α}_{i}}}{{\hat{q}}_{t}^{{α}_{i + 1}} - {\hat{q}}_{t}^{{α}_{i}}} \qquad ( 8 )$$
$${I}_{[ {\hat{q}}_{t}^{{α}_{i}} , {\hat{q}}_{t}^{{α}_{i + 1}} )} ( {y}_{t} ) = ε ( {y}_{t} - {\hat{q}}_{t}^{{α}_{i}} ) \cdot [ 1 - ε ( {y}_{t} - {\hat{q}}_{t}^{{α}_{i + 1}} ) ] \qquad ( 9 )$$
the proof of the above conclusion is as follows:
if the given prediction quantile is:
$$( {\hat{q}}_{t}^{{α}_{i}} , {α}_{i} ) , i = 0 , 1 , ... , r + 1 \qquad ( 10 )$$
$$wherein {α}_{0} = {\hat{q}}_{t}^{{α}_{0}} = 0 , {α}_{r + 1} = {\hat{q}}_{t}^{{α}_{r + 1}} = 1.$$
$$then :$$
$${𝒮}_{CRPS} ( \hat{Q} , Y ) = \frac{1}{T} {\sum }_{t = 1}^{T} {\int }_{0}^{1} {[ {F}_{t} ( p ) - ε ( p - {y}_{t} ) ]}^{2} dp \qquad ( 11 )$$
wherein Fₜ(p) is obtained by linear interpolation on (\hat{q}ₜ^{α}^{ᵢ}, αᵢ)ᵢ₌₀^{r+1};
the line segments determined by (\hat{q}ₜ^{α}^{ᵢ}, αᵢ) and (\hat{q}ₜ^{α}^{ᵢ₊₁}, αᵢ₊₁) are expressed by the following formulas:
$$z = {A}_{t}^{i} \cdot p + {B}_{t}^{i} \qquad ( 12 )$$
$${A}_{t}^{i} = \frac{{α}_{i + 1} - {α}_{i}}{{\hat{q}}_{t}^{{α}_{i + 1}} - {\hat{q}}_{t}^{{α}_{i}}} , {B}_{t}^{i} = \frac{{α}_{i} \cdot {\hat{q}}_{t}^{{α}_{i + 1}} - {α}_{i + 1} \cdot {\hat{q}}_{t}^{{α}_{i}}}{{\hat{q}}_{t}^{{α}_{i + 1}} - {\hat{q}}_{t}^{{α}_{i}}} \qquad ( 13 )$$
since Fₜ(p) is piecewise, a feasible region of Fₜ(p) is divided into the following mutually exclusive parts:
$$[ 0 , 1 ] ⇔ [ {\hat{q}}_{t}^{{α}_{0}} , {\hat{q}}_{t}^{{α}_{1}} ) ⋃ … ⋃ [ {\hat{q}}_{t}^{{α}_{i}} , {\hat{q}}_{t}^{{α}_{i + 1}} ) ⋃ … [ {\hat{q}}_{t}^{{α}_{r}} , {\hat{q}}_{t}^{{α}_{r + 1}} ) ⋃ {\hat{q}}_{t}^{{α}_{r + 1}} \qquad ( 14 )$$
F(p) is continuously derivable in each segment except the last isolated point \hat{q}ₜ^{a}^{ᵣ₊₁}; an indicator function corresponding to the probability interval [\hat{q}ₜ^{a}^{ᵢ},\hat{q}ₜ^{a}^{ᵢ₊₁}) is transformed into:
$$\begin{matrix}p ∈ [ {\hat{q}}_{t}^{{α}_{i}} , {\hat{q}}_{t}^{{α}_{i + 1}} ) \\ ⇒ p ∈ [ {\hat{q}}_{t}^{{α}_{i}} , + ∞ ) ⋂ ( - ∞ , {\hat{q}}_{t}^{{α}_{i + 1}} ) \\ \begin{matrix}⇒ ε ( p - {\hat{q}}_{t}^{{α}_{i}} ) = 1 and 1 - ε & ( p - {\hat{q}}_{t}^{{α}_{i + 1}} ) = 1\end{matrix} \\ ⇔ ε ( p - {\hat{q}}_{t}^{{α}_{i}} ) \cdot [ 1 - ε ( p - {\hat{q}}_{t}^{{α}_{i + 1}} ) ] = 1\end{matrix} \qquad ( 15 )$$
the indicator function corresponding to the last boundary point \hat{q}ₜ^{a}^{ᵣ₊₁} is transformed into:
$$\begin{matrix}p = {\hat{q}}_{t}^{{α}_{r + 1}} \\ ⇒ p ∈ [ {\hat{q}}_{t}^{{α}_{r + 1}} , {\hat{q}}_{t}^{{α}_{r + 1}} ] \\ ⇒ p ∈ [ {\hat{q}}_{t}^{{α}_{r + 1}} , + ∞ ) ⋂ ( - ∞ , {\hat{q}}_{t}^{{α}_{r + 1}} ] \\ ⇒ ε ( p - {\hat{q}}_{t}^{{α}_{r + 1}} ) = 1 and ε ( {\hat{q}}_{t}^{{α}_{r + 1}} - p ) = 1 \\ ⇔ ε ( p - {\hat{q}}_{t}^{{α}_{r + 1}} ) \cdot ε ( {\hat{q}}_{t}^{{α}_{r + 1}} - p ) = 1 \\ ⇔ ε ( p - 1 ) \cdot ε ( 1 - p ) = 1\end{matrix} \qquad ( 16 )$$
accordingly, Fₜ(p) is re-expressed as:
$${F}_{t} ( p ) = {\sum }_{i = 0}^{r} \{ ε ( p - {\hat{q}}_{t}^{{α}_{i}} ) \cdot [ 1 - ε ( p - {\hat{q}}_{t}^{{α}_{i + 1}} ) ] \cdot ( {A}_{t}^{i} \cdot p + {B}_{t}^{i} ) \} + ε ( p - 1 ) \cdot ε ( 1 - p ) \qquad ( 17 )$$
combining formula (11) and formula (17) to obtain formula (18):
$${\int }_{0}^{1} {[ {F}_{t} ( p ) - ε ( p - {y}_{t} ) ]}^{2} dp = {\int }_{0}^{1} {\{ {\sum }_{i = 0}^{r} \{ ε ( p - {\hat{q}}_{t}^{{α}_{i}} ) \cdot [ 1 - ε ( p - {\hat{q}}_{t}^{{α}_{i + 1}} ) ] \cdot {( {A}_{t}^{i} \cdot p + {B}_{t}^{i} )}^{2} \} + ε ( p - 1 ) - ε ( 1 - p ) - ε ( p - {y}_{t} ) \}}^{2} dp = {\sum }_{i = 0}^{r} {\int }_{0}^{1} \{ {{ε}^{2} ( p - {\hat{q}}_{t}^{{α}_{i}} ) [ 1 - ε ( p - {\hat{q}}_{t}^{{α}_{i + 1}} ) ]}^{2} {( {A}_{t}^{i} p + {B}_{t}^{i} )}^{2} \} dp + {\int }_{0}^{1} {ε}^{2} ( p - 1 ) {ε}^{2} ( 1 - p ) dp + {\int }_{0}^{1} {ε}^{2} ( p - {y}_{t} ) dp + 2 {\sum }_{i = 0}^{r} {\sum }_{j = 0 , j \neq i}^{r} {\int }_{0}^{1} \{ ε ( p - {\hat{q}}_{t}^{{α}_{i}} ) [ 1 - ε ( p - {\hat{q}}_{t}^{{α}_{i + 1}} ) ] ( {A}_{t}^{i} \cdot p + {B}_{t}^{i} ) ε ( p - {\hat{q}}_{t}^{{α}_{j}} ) [ 1 - ε ( p - {\hat{q}}_{t}^{{α}_{j + 1}} ) ] ( {A}_{t}^{j} \cdot p + {B}_{t}^{j} ) \} dp + 2 {\sum }_{i = 0}^{r} {\int }_{0}^{1} \{ ε ( p - {\hat{q}}_{t}^{{α}_{i}} ) \cdot [ 1 - ε ( p - {\hat{q}}_{t}^{{α}_{i + 1}} ) ] \cdot ( {A}_{t}^{i} \cdot p + {B}_{t}^{i} ) \cdot ε ( p - 1 ) \cdot ε ( p - 1 ) \} dp - 2 {\sum }_{i = 0}^{r} {\int }_{0}^{1} \{ ε ( p - {\hat{q}}_{t}^{{α}_{i}} ) \cdot [ 1 - ε ( p - {\hat{q}}_{t}^{{α}_{i + 1}} ) ] \cdot ( {A}_{t}^{i} \cdot p + {B}_{t}^{i} ) \cdot ε ( p - {y}_{t} ) \} dp - 2 {\int }_{0}^{1} ε ( p - 1 ) \cdot ε ( 1 - p ) ε ( p - {y}_{t} ) dp \qquad ( 18 )$$
then determining the following lemmas as the basis for further derivation:
$$\begin{matrix}Lemma 1 : for any x ∈ R \\ {ε}^{2} ( x ) = ε ( x ) {and [ 1 - ε ( x ) ]}^{2} = 1 - ε ( x )\end{matrix} \qquad ( 19 )$$
$$\begin{matrix}Lemma 2 : for any x ∈ R , and i \neq j \\ ε ( p - {\hat{q}}_{t}^{{α}_{i}} ) \cdot [ 1 - ε ( p - {\hat{q}}_{t}^{{α}_{i + 1}} ) ] \cdot ε ( p - {\hat{q}}_{t}^{{α}_{j}} ) \cdot [ 1 - ε ( p - {\hat{q}}_{t}^{{α}_{j + 1}} ) ] = 0\end{matrix} \qquad ( 20 )$$
Lemma 3: for any finite function f(x) on R, it has the following result:
$$\begin{matrix}{\int }_{0}^{1} ε & ( p - 1 ) \cdot [ 1 - ε ( p - 1 ) ] \cdot f & ( p ) & dp = 0\end{matrix} \qquad ( 21 )$$
it is proved in the following:
$$\begin{matrix}{\int }_{u}^{1} ε ( p - 1 ) \cdot ε ( 1 - p ) \cdot f ( p ) dp \\ = {lim}_{u \to {1}^{-}} {\int }_{0}^{u} ε ( p - 1 ) \cdot ε ( 1 - p ) \cdot f ( p ) dp \\ + {lim}_{u \to {1}^{-}} {\int }_{u}^{1} ε ( p - 1 ) \cdot ε ( 1 - p ) \cdot f ( p ) dp \\ = 0 + {lim}_{u \to {1}^{-}} f ( u ) \cdot ( 1 - u ) = f ( 1 ) \cdot 0 = 0\end{matrix}$$
combining with formula (19), formula(20), and formula (21), formula (18) is simplified as follows:
$${\int }_{0}^{1} {\{ {\sum }_{i = 0}^{r} \{ ε ( p - {\hat{q}}_{t}^{{α}_{i}} ) \cdot [ 1 - ε ( p - {\hat{q}}_{t}^{{α}_{i + 1}} ) ] \cdot ( {A}_{t}^{i} \cdot p + {B}_{t}^{i} ) \} + ε ( p - 1 ) \cdot ε ( 1 - p ) - ε ( p - {y}_{t} ) \}}^{2} dp = {\sum }_{i = 0}^{r} \{ {\int }_{0}^{1} \{ ε ( p - {\hat{q}}_{t}^{{α}_{i}} ) \cdot [ 1 - ε ( p - {\hat{q}}_{t}^{{α}_{i + 1}} ) ] \cdot {( {A}_{t}^{i} \cdot p + {B}_{t}^{i} )}^{2} \} dp - 2 {\int }_{0}^{1} \{ ε ( p - {\hat{q}}_{t}^{{α}_{i}} ) \cdot [ 1 - ε ( p - {\hat{q}}_{t}^{{α}_{i + 1}} ) ] \cdot ( {A}_{t}^{i} \cdot p + {B}_{t}^{i} ) \cdot ε ( p - {y}_{t} ) \} dp \} + 1 - {y}_{t} \qquad ( 23 )$$
because ∫₀¹{ε(p−\hat{q}ₜ^{a}^{ᵢ})·[1−ε(p−\hat{q}ₜ^{a}^{ᵢ₊₁})]·(Aₜⁱ·p+Bₜⁱ)²}dp is equal to the area of curve zᵢ=(Aₜⁱ·p+Bₜⁱ)² between p=\hat{q}ₜ^{α}^{ᵢ} and p=\hat{q}ₜ^{α}^{ᵢ₊₁}, therefore:
$${\int }_{0}^{1} \{ ε ( p - {\hat{q}}_{t}^{{α}_{i}} ) \cdot [ 1 - ε ( p - {\hat{q}}_{t}^{{α}_{i + 1}} ) ] \cdot {( {A}_{t}^{i} \cdot p + {B}_{t}^{i} )}^{2} \} dp = \frac{{( {A}_{t}^{i} \cdot {\hat{q}}_{t}^{{α}_{i + 1}} + {B}_{t}^{i} )}^{3}}{3 {A}_{t}^{i}} - \frac{{( {A}_{t}^{i} \cdot {\hat{q}}_{t}^{{α}_{i}} + {B}_{t}^{i} )}^{3}}{3 {A}_{t}^{i}} \qquad ( 24 )$$
$$however ,$$
$${\int }_{0}^{1} \{ ε ( p - {\hat{q}}_{t}^{{α}_{i}} ) \cdot [ 1 - ε ( p - {\hat{q}}_{t}^{{α}_{i + 1}} ) ] \cdot ( {A}_{t}^{i} \cdot p + {B}_{t}^{i} ) \cdot ε ( p - {y}_{t} ) \} dp$$
is equivalently converted into the following three cases:
$$( A ) when {\hat{q}}_{t}^{{α}_{i}} < {y}_{t} , {\hat{q}}_{t}^{{α}_{i + 1}} \leq {y}_{t} , namely ε ( {y}_{t} - {\hat{q}}_{t}^{{α}_{i + 1}} ) = 1 , {\int }_{0}^{1} \{ ε ( p - {\hat{q}}_{t}^{{α}_{i}} ) \cdot [ 1 - ε ( p - {\hat{q}}_{t}^{{α}_{i + 1}} ) ] \cdot ( {A}_{t}^{i} \cdot p + {B}_{t}^{i} ) \cdot ε ( p - {y}_{t} ) \} dp = 0 \qquad ( 25 )$$
$$( B ) when {\hat{q}}_{t}^{{α}_{i}} \leq {y}_{t} < {\hat{q}}_{t}^{{α}_{i + 1}} , namely ε ( {y}_{t} - {\hat{q}}_{t}^{{α}_{i}} ) \cdot [ 1 - ε ( {y}_{t} - {\hat{q}}_{t}^{{α}_{i + 1}} ) ] = 1 {\int }_{0}^{1} \{ ε ( p - {\hat{q}}_{t}^{{α}_{i}} ) \cdot [ 1 - ε ( p - {\hat{q}}_{t}^{{α}_{i + 1}} ) ] \cdot ( {A}_{t}^{i} \cdot p + {B}_{t}^{i} ) \cdot ε ( p - {y}_{t} ) \} dp = \frac{1}{2} {A}_{t}^{i} [ {( {\hat{q}}_{t}^{{α}_{i + 1}} )}^{2} - {y}_{t}^{2} ] + {B}_{t}^{i} ( {\hat{q}}_{t}^{{α}_{i + 1}} - {y}_{t} ) \qquad ( 26 )$$
$$( C ) when {y}_{t} < {\hat{q}}_{t}^{{α}_{i}} , namely [ 1 - ε ( {y}_{t} - {\hat{q}}_{t}^{{α}_{i}} ) ] = 1 {\int }_{0}^{1} \{ ε ( p - {\hat{q}}_{t}^{{α}_{i}} ) \cdot [ 1 - ε ( p - {\hat{q}}_{t}^{{α}_{i + 1}} ) ] \cdot ( {A}_{t}^{i} \cdot p + {B}_{t}^{i} ) \cdot ε ( p - {y}_{t} ) \} dp = \frac{1}{2} {A}_{t}^{i} [ {( {\hat{q}}_{t}^{{α}_{i + 1}} )}^{2} - {( {\hat{q}}_{t}^{{α}_{i}} )}^{2} ] + {B}_{t}^{i} ( {\hat{q}}_{t}^{{α}_{i + 1}} - {\hat{q}}_{t}^{{α}_{i}} ) \qquad ( 27 )$$
combining formula (23), formula (24), formula (25), formula (26) and formula (27) to obtain formula (28):
$${\int }_{0}^{1} {\{ {\sum }_{i = 0}^{r} \{ ε ( p - {\hat{q}}_{t}^{{α}_{i}} ) [ 1 - ε ( p - {\hat{q}}_{t}^{{α}_{i + 1}} ) ] ( {A}_{t}^{i} p + {B}_{t}^{i} ) \} + ε ( p - 1 ) ε ( 1 - p ) - ε ( p - {y}_{t} ) \}}^{2} dp = 1 - {y}_{t} + {\sum }_{i = 0}^{r} \{ \frac{{( {A}_{t}^{i} \cdot {\hat{q}}_{t}^{{α}_{i + 1}} + {B}_{t}^{i} )}^{3}}{3 {A}_{t}^{i}} - \frac{{( {A}_{t}^{i} \cdot {\hat{q}}_{t}^{{α}_{i}} + {B}_{t}^{i} )}^{3}}{3 {A}_{t}^{i}} - \{ {A}_{t}^{i} [ {( {\hat{q}}_{t}^{{α}_{i + 1}} )}^{2} - {y}_{t}^{2} ] + 2 {B}_{t}^{i} ( {\hat{q}}_{t}^{{α}_{i + 1}} - {y}_{t} ) \} ε ( {y}_{t} - {\hat{q}}_{t}^{{α}_{i}} ) [ 1 - ε ( {y}_{t} - {\hat{q}}_{t}^{{α}_{i + 1}} ) ] - \{ \{ {A}_{t}^{i} [ {( {\hat{q}}_{t}^{{α}_{i + 1}} )}^{2} - {( {\hat{q}}_{t}^{{α}_{i}} )}^{2} ] + 2 {B}_{t}^{i} ( {\hat{q}}_{t}^{{α}_{i + 1}} - {\hat{q}}_{t}^{{α}_{i}} ) \} [ 1 - ε ( {y}_{t} - {\hat{q}}_{t}^{{α}_{i}} ) ] \} \qquad ( 28 )$$
then, combining formula (18) and formula (28), the CRPS in formula (11) is re-expressed as formula (29):
$${𝒮}_{CRPS} ( \hat{Q} , Y ) = \frac{1}{T} {\sum }_{t = 1}^{T} \{ 1 - {y}_{t} + {\sum }_{i = 0}^{r} \{ \frac{{( {A}_{t}^{i} \cdot {\hat{q}}_{t}^{{α}_{i + 1}} + {B}_{t}^{i} )}^{3}}{3 {A}_{t}^{i}} - \frac{{( {A}_{t}^{i} \cdot {\hat{q}}_{t}^{{α}_{i}} + {B}_{t}^{i} )}^{3}}{3 {A}_{t}^{i}} - \{ {A}_{t}^{i} [ {( {\hat{q}}_{t}^{{α}_{i + 1}} )}^{2} - {y}_{t}^{2} ] + 2 {B}_{t}^{i} ( {\hat{q}}_{t}^{{α}_{i + 1}} - {y}_{t} ) \} ε ( {y}_{t} - {\hat{q}}_{t}^{{α}_{i}} ) [ 1 - ε ( {y}_{t} - {\hat{q}}_{t}^{{α}_{i + 1}} ) ] - \{ \{ {A}_{t}^{i} [ {( {\hat{q}}_{t}^{{α}_{i + 1}} )}^{2} - {( {\hat{q}}_{t}^{{α}_{i}} )}^{2} ] + 2 {B}_{t}^{i} ( {\hat{q}}_{t}^{{α}_{i + 1}} - {\hat{q}}_{t}^{{α}_{i}} ) \} [ 1 - ε ( {y}_{t} - {\hat{q}}_{t}^{{α}_{i}} ) ] \} \} \qquad ( 29 )$$
the expression of CRPS in formula (29) is equivalent to that in formula (3), and CRPS is derivable, so CRPS is trained as a loss function;
S22, using the transformed derivable CRPS as the loss function to train WQPMMSA;
taking the CRPS in formula (29) as the loss function for training WQPMMSA, the training of WQPMMSA is abstracted as the following optimization problem:
$$\begin{matrix} & {min}_{θ} {𝒮}_{C R P S} ( \hat{Q} , Y ) \\ s . t . & {\hat{q}}_{t}^{{α}_{i}} - {\hat{q}}_{t}^{{α}_{i + 1}} < 0 , i = 0 , 1 , … , r , t = 1 , 2 , … , T\end{matrix} \qquad ( 30 )$$
constraint condition: ∃t, \hat{q}ₜ^{a}^{₀}=0 and \hat{q}ₜ^{a}^{ᵣ₊₁}=1, wherein formula (30) is implemented by a double gradient descent algorithm; firstly, the Lagrangian function [symbol] _{θ,λ} is defined as:
$$\begin{matrix}{ℒ}_{θ , λ} = {𝒮}_{C R P S} ( \hat{Q} , Y ) + {\sum }_{t = 1}^{T} {\sum }_{i = 0}^{r} & {λ}_{t}^{i} (\end{matrix} {\hat{q}}_{t}^{{α}_{i}} - {\hat{q}}_{t}^{{α}_{i + 1}} ) \qquad ( 31 )$$
constraint condition, λₜⁱ≥0, in the above formula, θ is a parameter set of the neural network, and λ is a Lagrange multiplier, then, using the double gradient descent algorithm and using [symbol] _{θ,λ} as the direct loss function to train WQPMMSA, θ and λₜⁱ are updated alternately in the double gradient descent algorithm for the training of WQPMMSA.
